(19) United States
(12) Patent Application Publication
(10) Pub. No.: US 2006/0118388 A1
(43) Pub. Date: Jun. 8, 2006

(54) Arrangement for changing the spacing on a conveying chain

(75) Inventor: Russell Varone, Red Lion, PA (US)

Correspondence Address: VENABLE LLP, P.O. BOX 34385, WASHINGTON, DC, 20045-9998, US

(73) Assignee: GRAHAM PACKAGING COMPANY, L.P., York, PA (US)

(21) Appl. No.: 11/003,366

(22) Filed: Dec. 6, 2004

(51) Int. Cl. B65G 17/20

(52) U.S. Cl. 198/678.1; 198/867.09

(57) ABSTRACT

A conveying arrangement includes a conveying chain having a series of stems on which items to be conveyed can be spaced at a first distance. The conveying chain also includes a plurality of adapter blocks attached to at least some of the stems such that the items can be spaced at a second distance.

### BACKGROUND OF THE INVENTION

1. Field of the Invention

The present invention relates generally to a conveying arrangement for changing the spacing of articles on a conveying chain.

2. Related Art

As shown in FIG. 1, a conventional drive chain 1 has stems 2 with a spacing or pitch A of about 1.5 inches. The drive chain 1 is used to transport mounting chucks or other types of carriers for transporting objects. For example, this arrangement can be used to transport containers mounted thereon (not shown) through a spraying operation and can be hundreds or thousands of feet long, for example, about 1300 feet.

As shown in FIG. 2, a drive chain 1 can have a mounting chuck 4 mounted on every other stem 2 such that the spacing between each mounting chuck 4 is about twice that of the spacing between adjacent stems 2. Thus, in the exemplary embodiment, the spacing B between mounting chucks will be about 3.0 inches. In the use described above, the first spacing B of 3.0 inches between mounting chucks 4 is suitable for conveying containers of 16 ounces and smaller on each mounting chuck 4. However, the first spacing of 3.0 inches may not be sufficient to accommodate bottles of greater than 16 ounces on each mounting chuck 4. For example, if the first spacing of 3.0 inches between mounting chucks is used, a container greater than 16 ounces can only mounted on every other mounting chuck in the arrangement of FIG. 2. In the alternative, a mounting chuck 4 could be arranged on every third stem such that the containers could be mounted on each mounting chuck. This provides a spacing of 4.5 inches between chucks, which can result in an excessive amount of space between objects and an undesirable reduction in the number of objects attachable to the drive chain. Either of these scenarios for a container of greater than 16 ounces results in decreased production and wasted product used in the spraying process.

### BRIEF SUMMARY OF THE INVENTION

A conveying arrangement in accordance with the present invention includes a conveying chain having a series of stems on which items to be conveyed can be spaced at a first distance, and a plurality of adapter blocks attached to at least some of the stems such that the items can be spaced at a second distance. As such, the plurality of adapter blocks change the spacing of the conveying chain.

The plurality of adapter blocks include a plurality of first adapter blocks adapted to receive an item to be conveyed at a first position offset with respect to the chain stems, and a plurality of second adapter blocks adapted to receive an item to be conveyed at a second, different position offset with respect to the chain stems. The plurality of first and second adapter blocks are arranged such that the items can be spaced at the second distance.

Further objectives and advantages, as well as the structure and function of preferred embodiments will become apparent from a consideration of the description, drawings, and examples.

### BRIEF DESCRIPTION OF THE DRAWINGS

The foregoing and other features and advantages of the invention will be apparent from the following, more particular description of a preferred embodiment of the invention, as illustrated in the accompanying drawings wherein like reference numbers generally indicate identical, functionally similar, and/or structurally similar elements.

FIG. 1 depicts a conventional conveying chain used in conjunction with an exemplary embodiment of the present invention.

FIG. 2 depicts a conveying arrangement with conveyed items spaced at a first spacing.

FIG. 3 depicts an exemplary embodiment of a conveying arrangement in accordance with the present invention in which the conveyed items are spaced at a second spacing.

FIG. 4A depicts a bottom view of an exemplary embodiment of a half offset adapter block in accordance with the present invention.

FIG. 4B depicts a top view of the half offset adapter block shown in FIG. 4A.

FIG. 4C depicts a side view of the half offset adapter block shown in FIG. 4A.

FIG. 4D depicts a cross sectional view of the half offset adapter block shown in FIG. 4C through line I-I.

FIG. 5A depicts a bottom view of an exemplary embodiment of a full offset adapter block in accordance with the present invention.

FIG. 5B depicts a top view of the full offset adapter block shown in FIG. 5A.

FIG. 5C depicts a side view of the full offset adapter block shown in FIG. 5A.

FIG. 5D depicts a cross sectional view of the half offset adapter block shown in FIG. 5C through line II-II.

### DETAILED DESCRIPTION OF THE INVENTION

Embodiments of the invention are discussed in detail below. In describing embodiments, specific terminology is employed for the sake of clarity. However, the invention is not intended to be limited to the specific terminology so selected. While specific exemplary embodiments are discussed, it should be understood that this is done for illustration purposes only. A person skilled in the relevant art will recognize that other components and configurations can be used without parting from the spirit and scope of the invention. Any reference cited herein is hereby incorporated by reference.

The present invention utilizes a combination of adapter blocks to change the spacing of the conveying chain from a first spacing to a second spacing. In the exemplary embodiment, the spacing of the mounting chucks can be changed from 3.0 inches to 3.5 inches, which can more efficiently accommodate mounting chucks for, for example, bottles that are greater than 16 ounces.

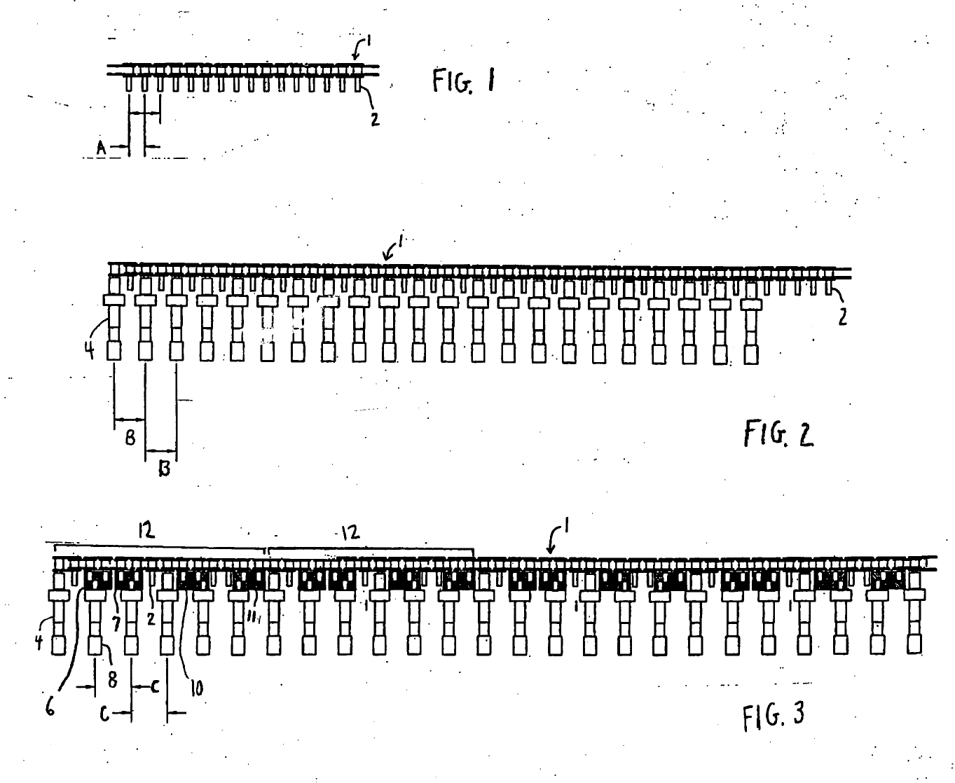

As shown in FIG. 3, in the exemplary embodiment, two types of adapter blocks are used to change the spacing from the first spacing B, as shown in FIG. 2, to the second spacing C. A first type of adapter block is a half offset block 6, 7, which receives two chain stems in upper bores and receives a mounting chuck in a lower bore at a position horizontally outside of the two chain stems. A second type of adapter block is a full offset block 10, 11, which receives two chain stems in upper bores and receives a mounting check in a lower bore at a position horizontally inside of the two chain stems. A plurality of the half adapter blocks 6, 7 and the full adapter blocks 10, 1 1 are arranged such that the items can be spaced at the second spacing C.

In the exemplary embodiment of FIG. 3, the half offset adapter blocks 6, 7 and the full offset adapter blocks 10, 11 are arranged on the stems 4 to form a unit 12 of conveying stems 4 to space the items at the second spacing C. A single unit 12 has the following consecutive arrangement, as shown from left to right in FIG. 3: a first stem has a mounting chuck mounted thereon; a second stem is uncovered; third and fourth stems have one of the half offset adapter blocks 6 mounted thereon; fifth and sixth stems have another one of the half offset adapter blocks 7 mounted thereon; a seventh stem is uncovered; an eighth stem has a mounting chuck 4 mounted thereon; ninth and tenth stems have one of the full offset adapter blocks 10 mounted thereon; eleventh and twelfth stems is uncovered; and thirteenth and fourteenth stems have another one of the full offset adapter blocks 11 mounted thereon. Each of the lower bores of the full adapter blocks 10, 11 and the offset adapter blocks 6, 7 receive one of the mounting chucks 4. As shown in FIG. 3, the half offset adapter block 6 is the same as half offset adapter block 7, except that adapter block 7 is rotated about its vertical axis with respect to adapter block 6. Similarly, the full offset adapter block 10 is the same as full offset adapter block 11, except that adapter block 11 is rotated about its vertical axis with respect to adapter block 10.

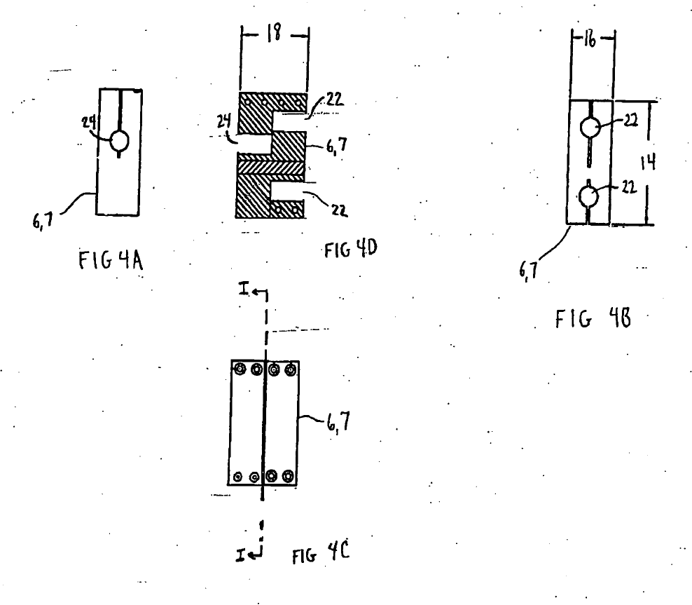

FIGS. 4A-4D show various views of an exemplary embodiment of the half offset adapter block 6, 7.

The following dimensions are by way of example only. The half offset blocks 6, 7 are generally cube shaped with a length 14 of about 2.7 inches, a width 16 of about 1 inch, and a height 18 of about 1.6 inches. The two upper bores 22 of each half offset block 6, 7 have a diameter of about 0.4 inches. Each of the upper bores 22 of the half offset block 6, 7 has a center about 0.6 inches from an adjacent end of the half offset block, and the lower bore 24 of each half offset block 6, 7 has a diameter of about 0.4 inches. The lower bore 24 of the half offset block 6, 7 has a center about 1.1 inches from one of the ends of the half offset block.

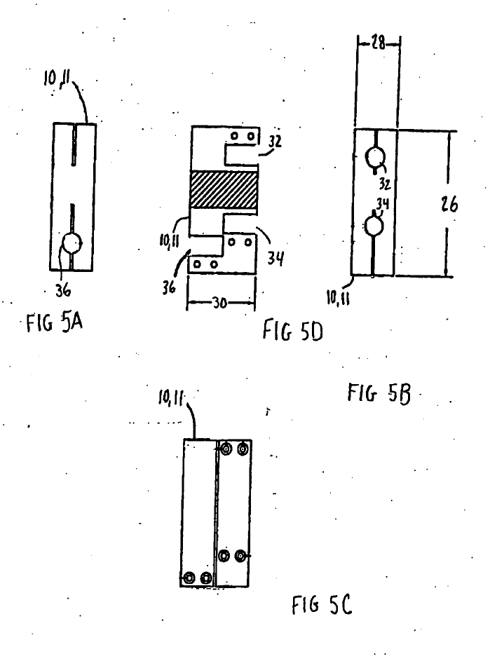

FIGS. 5A-5D show various views of an exemplary embodiment of the full offset adapter block 10, 11

The following dimensions are by way of example only. Each full offset block 10, 11 is generally cube shaped with a length 26 of about 3.2 inches, a width 28 of about 1 inch, and a height 30 of about 1.6 inches. The two upper bores 32, 34 of the full offset block 10, 11 have a diameter of about 0.4 inches. One of the upper bores 32 of the full offset block 10, 11 has a center about 0.6 inches from one of the ends of the full offset block, and the other upper bore 34 of the full offset block 10, 11 has a center about 2.1 inches from the same end of the full offset block 10, 11. The lower bore 36 of the full offset block 10, 11 has a diameter of about 0.4 inches and a center that is about 2.6 inches from the end of the full offset block.

Although the illustrated embodiment of the adapter blocks are adapted to receive mounting checks, other embodiments can include mounting chucks formed integrally therewith. Further, although the exemplary embodiment desribed herein is used for transporting containers, the invention can also be used to transport other articles suspended from a drive chain. The use of half offset blocks and full offset blocks is by way of example. A person skilled in the art could utilize differently dimensional sets of offset blocks to achieve a variety of spacings. The spacings could be similar or dissimilar depending on the particular use. The invention is useful for obtaining similar or regular spacings between chucks or objects being conveyed. It will be understood that more than two types of offset blocks may be utilized to achieve different spacings.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

What is claimed is:

1. A conveying arrangement, comprising:
a conveying chain having a series of stems on which items to be conveyed can be spaced at a first distance; and
a plurality of adapter blocks attached to at least some of the stems such that the items can be spaced at a second distance.

2. The arrangement of claim 1, wherein the plurality of adapter blocks include
a plurality of first adapter blocks adapted to receive an item to be conveyed at a first position offset with respect to the chain stems, and
a plurality of second adapter blocks adapted to receive an item to be conveyed at a second position offset with respect to the chain stems, wherein the plurality of first and second adapter blocks are arranged such that the items can be spaced at the second distance.

3. The arrangement of claim 2, wherein the first adapter blocks are half offset adapter blocks having two upper bores on an upper surface for receiving two adjacent stems and a lower bore on an opposite, lower surface, in between the two upper bores, for receiving one of the items to be conveyed.

4. The arrangement of claim 3, wherein the second adapter blocks are full offset adapter blocks having two upper bores on an upper surface for receiving two adjacent stems and a lower bore on an opposite, lower surface, outside of the two upper bores, for receiving an item to be conveyed.

5. The arrangement of claim 1, wherein the first distance is less than the second distance.

6. The arrangement of claim 4, wherein the half offset adapter blocks and the full offset adapter blocks are arranged on the stems to form a unit of conveying stems to space the items at the second distance, said unit including the following consecutive arrangement
a first stem having one of the items to be conveyed,
a second stem being uncovered,
third and fourth stems having one of the half offset adapter blocks mounted thereon,
fifth and sixth stems having another one of the half offset adapter blocks mounted thereon,
a seventh stem being uncovered,
an eighth stem having one of the items to be conveyed,
ninth and tenth stems having one of the full offset adapter blocks mounted thereon,
eleventh and twelfth stems being uncovered, and
thirteen and fourteen stems having another one of the full offset adapter blocks mounted thereon,
wherein each of the full and offset adapter blocks receive one of the items to be conveyed.

7. The arrangement of claim 1, wherein the first distance is about 3 inches and the second distance is about 3.5 inches.

8. The arrangement of claim 4, wherein the half offset blocks are generally cube shaped with a length of about 2.7 inches, a width of about 1 inch, and a height of about 1.6 inches.

9. The arrangement of claim 8,
wherein the two upper bores of each half offset block have a diameter of about 0.4 inches and wherein each of the upper bores of the half offset block has a center about 0.6 inches from an adjacent end of the half offset block, and
wherein the lower bore of each half offset block has a diameter of about 0.4 inches and wherein the lower bore of the half offset block has a center about 1.1 inches from one of the ends of the half offset block.

10. The arrangement of claim 4, wherein each full offset block is generally cube shaped with a length of about 3.2 inches, a width of about 1 inch, and a height of about 1.6 inches.

11. The arrangement of claim 10,
wherein the two upper bores of the full offset block have a diameter of about 0.4 inches and wherein one of the upper bores of the full offset block has a center about 0.6 inches from one of the ends of the full offset block and the other one of the upper bores of the full offset block has a center about 2.1 inches from the one end of the full offset block, and
wherein the lower bore of the full offset block has a diameter of about 0.4 inches and wherein the lower bore of the full offset block has a center about 2.6 inches from the one end of the full offset block.

12. The arrangement of claim 1, wherein the items to be conveyed are bottle carriers.

13. The arrangement of claim 1, further comprising bottle carriers arranged in the lower bores of the half offset blocks and in the lower bores of the full offset blocks.

14. An arrangement for changing the spacing of items on a conveying chain having stems spaced at a first distance, the arrangement comprising:
a plurality of first adapter blocks, each adapted to receive an item to be conveyed at a first position offset with respect to the chain stems, and
a plurality of second adapter blocks, each adapted to receive an item to be conveyed at a second position offset with respect to the chain stems, wherein the first and second adapter blocks are arranged such that the items can be spaced at a second distance.

15. The arrangement of claim 14, wherein the first adapter blocks are half offset adapter blocks having two upper bores on an upper surface for receiving two adjacent stems and a lower bore on an opposite lower surface, in between the two upper bores, for receiving one of the items to be conveyed.

16. The arrangement of claim 15, wherein the second adapter blocks are full offset adapter blocks having two upper bores on an upper surface for receiving two adjacent stems and a lower bore on an opposite, lower surface, outside of the two upper bores, for receiving an item to be conveyed.

17. The arrangement of claim 14, wherein the first distance is about 3 inches and the second distance is about 3.5 inches.

18. The arrangement of claim 14, wherein the items to be conveyed are bottle carriers.

19. A method for altering the distance between items to be conveyed in a conveying system, comprising:
providing a conveying chain having a series of stems on which the items to be conveyed can be spaced apart at a first distance, and
providing a plurality of adapter blocks attached to at least some of the stems such that the items to be conveyed can be spaced at a second distance.

20. The method of claim 19, wherein the step of providing the adapter blocks includes providing a plurality of first adapter blocks adapted to receive an item to be conveyed at a first position offset with respect to the chain stems, and providing a plurality of second adapter blocks adapted to receive an item to be conveyed at a second position offset with respect to the chain stems, wherein the plurality of first and second adapter blocks are arranged such that the items can be spaced at the second distance.
